(19) United States
(12) Patent Application Publication
(10) Pub. No.: US 2010/0176144 A1
(43) Pub. Date: Jul. 15, 2010

(54) ROLLED ANIMAL WASTE COLLECTION PADS

(75) Inventor: Barry Askinasi, Mt. Sinai, NY (US)

Correspondence Address: DARBY & DARBY P.C., P.O. BOX 770, Church Street Station, New York, NY, 10008-0770, US

(73) Assignee: Four Paws Products, Ltd., Hauppage, NY (US)

(21) Appl. No.: 12/544,359

(22) Filed: Aug. 20, 2009

Related U.S. Application Data
(60) Provisional application No. 61/143,502, filed on Jan. 9, 2009.

(51) Int. Cl. A01K 29/00; B65H 5/28

(52) U.S. Cl. 221/71; 119/171

(57) ABSTRACT

A series of animal waste pads connected together where the separation between animal waste pads is defined by a perforation and the animal waste pads are wound around a roll that is adapted to fit an animal waste pad dispenser.

### CROSS-REFERENCE TO RELATED APPLICATION

The present application claims the benefit of U.S. Provisional Application Ser. No. 61/143,502, filed on Jan. 9, 2009, which is hereby incorporated by reference in its entirety.

### FIELD OF THE INVENTION

The present invention relates to disposable animal waste pads that are connected via perforations and rolled so as to a form a continuous sheet of multiple waste pads that can be separated at the location of the perforations and used within an animal waste pad dispenser and holder.

### BACKGROUND OF THE INVENTION

Disposable waste pads provide convenience for owners of domestic animals such as dogs. A waste pad provides an area for a dog to relieve itself without damaging flooring. These pads are useful for the housebreaking process for puppies as well as for older dogs that are left in the home for prolonged periods of time.

Waste pads are often left on the floor for the pet to use. Providing the pads in a predetermined area provides consistency to the animal using the pads and helps reinforce the use of the pad in a specified area. However, pads left by themselves can be easily moved across the floor either by the pet owner kicking or stepping on the pad or when the animal uses the pad. Also, a dog may chew, gnaw, drag, fold, cause the pad to bunch up or otherwise damage or destroy the pad. Therefore, holders have been developed for containing the pad in a single location and to hold the pad in place.

Traditionally, pads have been sold in packages where the pads are laid one on top of another, and then enclosed within packaging. However, this type of packaging is not conducive for use with animal waste pad holders.

Therefore, it would be advantageous to have pads that are configured to be packaged in a relatively small area but able to be used in animal waste pad dispensers and holders.

### BRIEF DESCRIPTION OF THE DRAWINGS

The foregoing and other features of the present invention will be more readily apparent from the following detailed description and drawings of illustrative embodiments of the invention in which:

FIG. 1 is a perspective view of a roll of waste pads in accordance with one embodiment of the invention;

FIG. 2 is a top view of a roll of animal waste pads with a portion of the waste pads unrolled in accordance with one embodiment of the invention;

FIG. 3 is a side view of a roll of animal waste pads in accordance with one embodiment of the invention;

FIG. 4 a cutaway view of a waste pad in accordance of one embodiment of the invention;

FIG. 5 shows an exploded perspective view of the waste pads within the roll of waste pads of the present invention;

FIG. 6 shows a perspective view of a dispenser and holder within which the invention may be used; and

FIG. 7 is an exploded view of a dispenser and holder within which the invention may be used;

FIG. 8 is a perspective view of the bottom of the dispenser and holder within which the invention may be used; and

FIG. 9 is a closeup view of one embodiment of a support on the bottom of a dispenser and holder within which the invention may be used.

### DETAILED DESCRIPTION OF THE PREFERRED EMBODIMENTS

Various embodiments now will be described more fully hereinafter with reference to the accompanying drawings, which form a part hereof, and which show, by way of illustration, specific embodiments. However, this invention may be embodied in many different forms and should not be construed as limited to the embodiments set forth herein. Rather, these embodiments are provided so that this disclosure will be thorough and complete, and will fully convey the scope of the invention to those skilled in the art. The following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

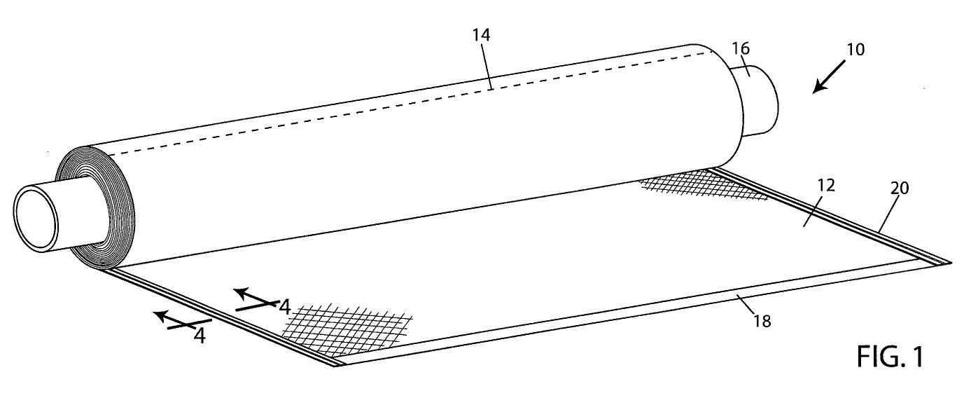

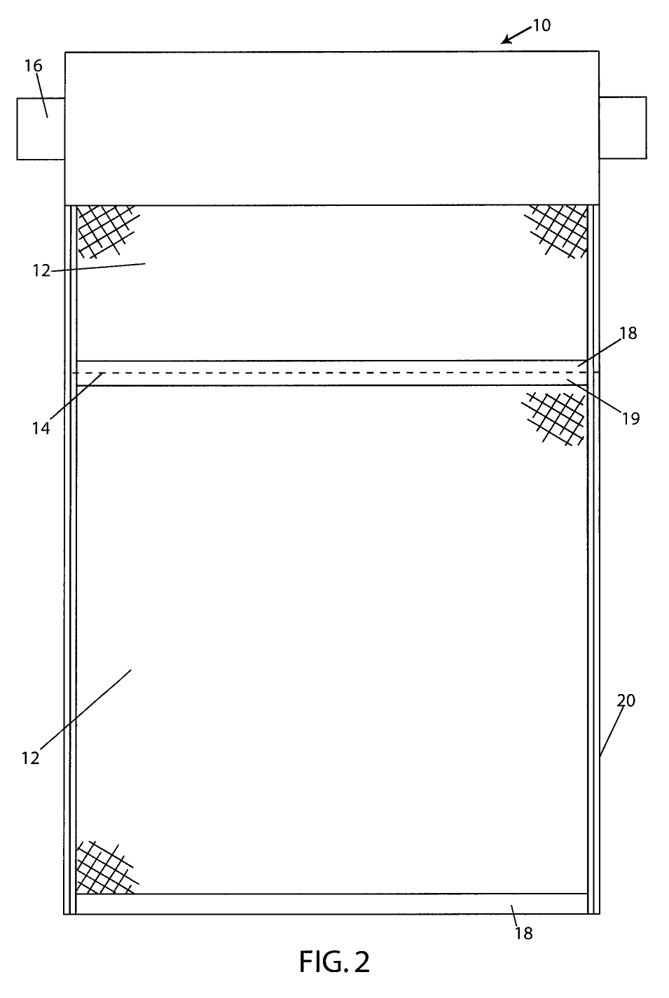

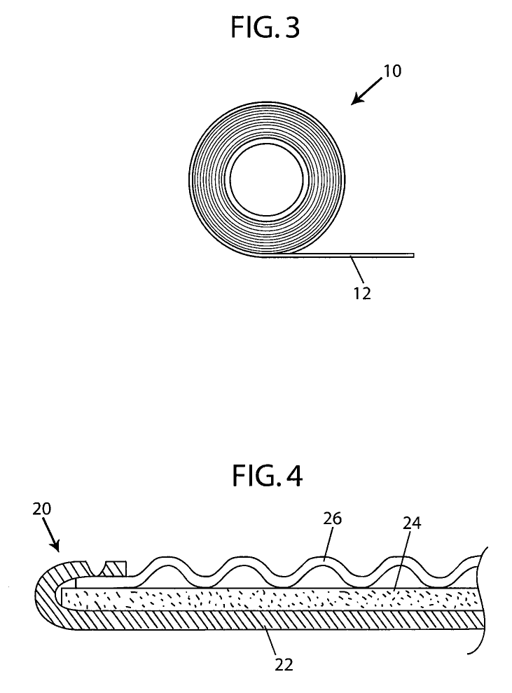

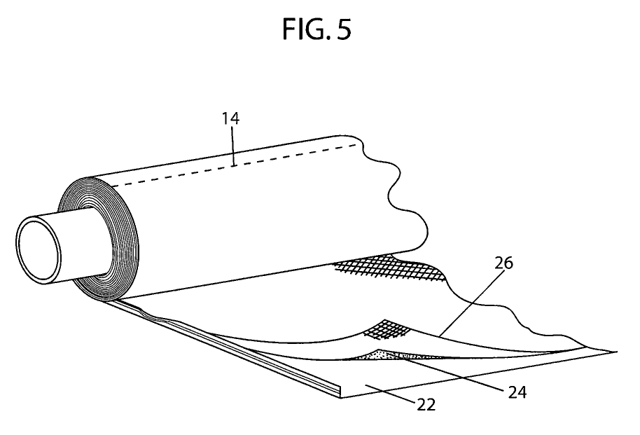

Rolled waste pads 10 are shown in FIGS. 1 through 5. Rolled waste pads 10 are comprised of a series of waste pads 12 that are connected together through perforation 14 and wound around roll support 16. As shown in FIGS. 4 and 5, each waste pad is comprised of at least three layers. The first layer 26 is usually a non-woven layer made of a material that has a wicking action, such as polyester. Second layer 24 is usually a cellulose tissue embedded with a super absorbent polymer. As one example, the super absorbent polymer may be an acrylate salt which acts as a desiccant. Third layer 22 may be made of polypropylene and functions as a backing that is generally an impermeable layer. The three layers are usually combined together with glue or an adhesive. As shown in FIG. 1, the edge of the waste pad has folded edge 20. In forming this folded edge 20, third layer 22 is folded over the end of first layer 26 and second layer 24, and then attached to the top surface of first layer 26. The leading edge of each pad 18 is comprised only of third layer 22, which forms leading edge 18. Leading edge 18 is separated from the next concurrent waste pad 12 of rolled waste pads 10 by perforation 14.

Waste pads 12 are rolled around roll support 16 in a relatively tight manner so that the packaging of the waste pads remains relatively compact. One advantage of this configuration is that, while stacked waste pads can be bulky because of the space taken up by the absorbent layer, rolled waste pads can be compressed when rolled so as to take up a smaller space. Roll support 16 may extend outside of the area of the waste pads so as to fit into an animal waste pad dispenser. Within the dispenser, roll support 16 may rotate about its axis as the animal waste pads are removed from the roll. In an alternative embodiment, roll support 16 may not extend outside of the area of the waste pads, but instead may be configured to receive an extension from the waste pad dispenser.

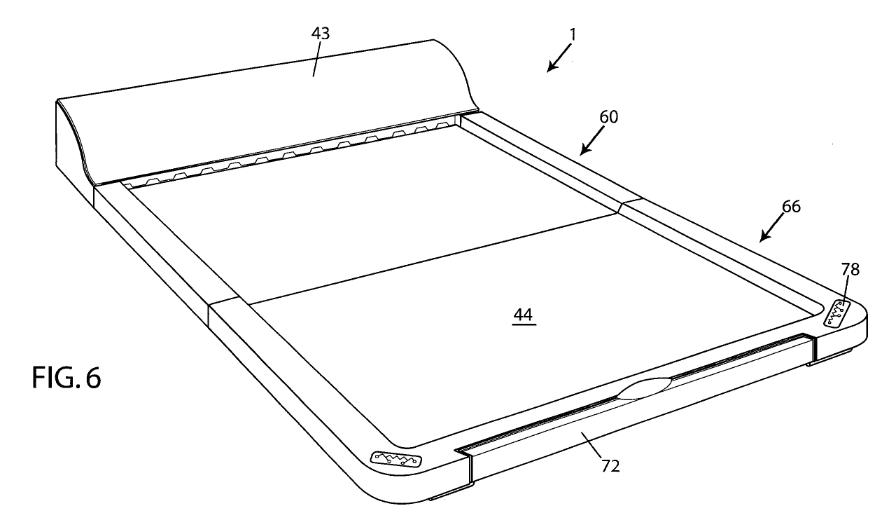

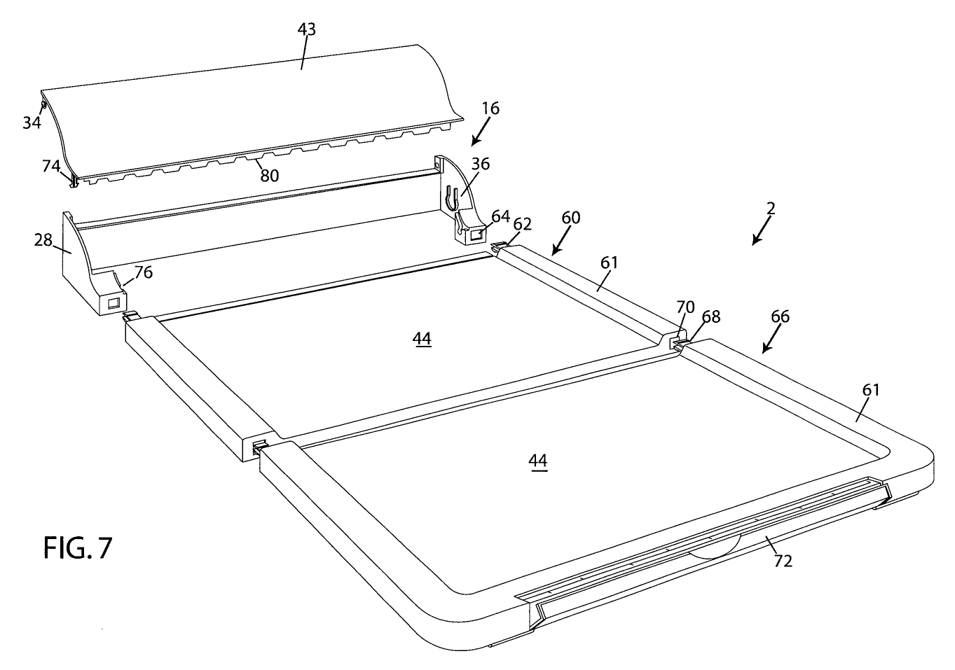

An embodiment of a waste pad dispenser and holder that is configured to contain the rolled waste pads of the present invention is shown in FIGS. 6 and 7. Waste pad dispenser and holder 1 is comprised of dispenser 16 and holder 2. Holder 2 may be comprised of two separate sections, first waste bed section 60 and second waste bed section 66, which together form waste bed 44. In one embodiment, waste bed 44 is substantially flat and planar. In another embodiment, waste bed 44 may be concave so as to pool waste towards its center. The two waste bed sections are connectable through prongs 68 attached to one end of second waste bed section 66 that interface with prong receiving openings 70 of first waste bed section 60. Similarly, first waste bed section 60 is removably connectable to dispenser 16 through prongs 62 and prong receiving openings 64 in dispenser 16. By providing different sections for the waste pad holder and dispenser, the device may be sold in a reduced packaging and therefore meet requirements of retailers having space constrictions for their shelves. The reduced size also decreases shipping costs and the difficulty in a consumer bringing the waste pad dispenser and holder to their homes. The use of prongs and prong receiving openings enables a consumer to quickly and easily assemble the device without the use of tools.

Waste bed 44, in one embodiment, contains raised edges 61 that extend along the edges of three peripheral sides of the waste bed. Raised edges 61 act to contain waste pads within waste bed 44 and also to prevent any leaking or spillage off the waste pad holder. On one end of waste bed 44 is pad clamp 72. Pad clamp 72 is comprised of a hinged cover that acts as a clamp when one end of waste pad 42 is placed within the clamp. As an alternative, the peripheral edges of waste bed 44 may contain pad retainers 78. Pad retainers 78 are comprised of a deformable plastic or rubber. When the waste pad is inserted into pad retainers 78, the deformable material initially moves to create a space through with the waste pad may be inserted. After insertion of the waste pad, the deformable material moves back into its original position, engaging and holding the waste pad in place. Any combination or number of pad clamps and pad holders may be used to hold the waste pad in place.

In another embodiment, the lower surface of the waste pads may be treated with a slightly adhesive material that increases the tackiness of the surface. When the waste pads are place over bed 44, the slightly adhesive nature of the back surface of the waste pads will cause them to adhere to bed 44. However, the slightly adhesive nature of the back surface will have to be low enough that the pads may be unrolled from the roll of waste pads. Alternatively, bed 44 may be made of a material that has an adhesive property relative to the back surface of the waste pads to accomplish the same results.

Dispenser 16 may contain cradles 36 for holding waste pad roll 10. In this embodiment, roll 10 may be inserted so as to rest within cradles 36 without deformation of either end face 28. In one embodiment of the invention, pad roll 10 is provided with a spindle in the replacement waste pad roll so that the user need only insert the replacement waste pad roll directly into the dispenser. Any other method of rotatably holding waste pad roll 40 within dispenser 16 may be used.

In operation, a user will open lid 43 to gain access to the interior of dispenser 16. The user would then place a roll of animal waste pads within dispenser 16, which are rotatably held in place by cradles 36. The user may then extend an animal waste pad across waste bed 44 and insert the end of the animal waste pad into pad clamp 72 or within one or more of pad retainers 78. The user may then close lid 43 to hold the opposite end of the animal waste pad in place. Alternatively, lid 43 may simply rest against the opposite end of the waste pad holder to trap the waste pad against waste bed 44. In yet another embodiment, lid 43 may have extensions 74 that mate into an extension receiving opening to removably hold the lid in a closed position.

After a waste pad that is lying on waste bed 44 is soiled, the pet owner will disengage pad clamp 72 or pad retainers 78. The pad may then be pulled off of waste bed 44, thereby causing the next trailing, and unused waste pad to be positioned on the waste bed. The pet owner may then remove the soiled waste pad by separating it at the perforation from the next waste pad. Alternatively, the pet owner may chose to first detach the current waste pad from the following pad and manually advance the next waste pad into position. In yet another embodiment, the user would not lift lid 43 when changing waste pad. Rather, the waste pad would come out between a slot created between lid 43 and the edge of waste bed 44. In yet another embodiment, extended edge 80 would act to cut waste pad at that location when lid 43 is closed.

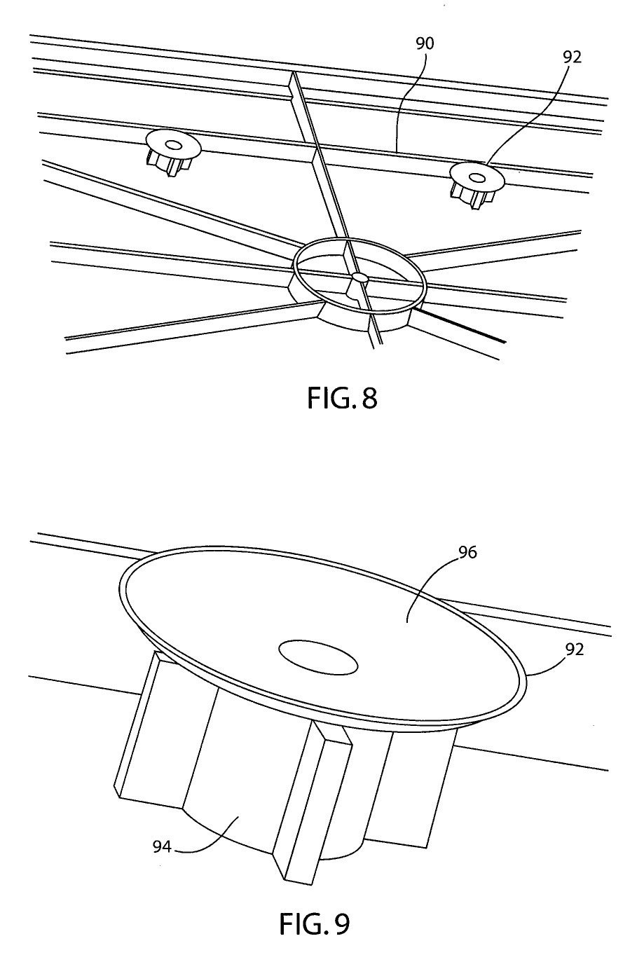

FIG. 8 shows the bottom side of the waste pad dispenser and holder. To permit the dispenser and holder to have sufficient structural strength, but be made of less material and therefore lighter, the bottom of the dispenser and holder contains structures 90. Structures 90 provide support to the bed of the device. At various locations along the bottom of the device are feet 92. Preferably, there are three or more feet 92 located along the bottom of the dispenser and holder.

A more detailed view of feet 92 is shown in FIG. 9. Feet 92 are comprised of support 94 and deformable piece 96. Support 94 is connected on one end to the dispenser and holder, and may extend the same distance or beyond the depth of structures 90 and/or the side edges of the dispenser and holder. Support 94 may be hollow on the inside for receiving a shaft attached to deformable piece 96. The shaft would hold deformable piece 96 in place. Deformable piece 96 may be made of a rubber or other deformable material that retains its shape. When the device is placed on the floor, the various deformable pieces hold the device above the floor and provide a non-sliding firm contact with the ground for the device. One advantage of feet 92 is that the device will not slide along the floor as easily. Another advantage is that feet 92 will increase the stability of the device. In other words, when the animal steps on one side of the device, the other side of the device will not move or lift, which would create noise and uncertainty in the animal in using the product.

Although the invention is shown in use with both a waste pad dispenser and holder, in another embodiment, the invention may only be used with a dispenser. The dispenser may be located on a shelf or may be wall mounted.

While the invention has been particularly shown and described with reference to preferred embodiments thereof, it will be understood by those skilled in the art that various changes in form and details may be made therein without departing from the spirit and scope of the invention.

1. A roll of animal waste pads comprising:
a substantially rigid center support;
a plurality of animal waste pads rolled around the center support and having,
a first layer made of a non-woven material with a wicking action,
a second absorbent layer, and
a third substantially impermeable backing layer;
each of the plurality of animal waste pads having leading, trailing and side edges;
the side edges of each of the plurality of pads having a folded structure where the third backing layer is folded over and attached to a top surface of the first layer; and
the plurality of animal waste pads are consecutively connected together wherein a trailing edge of a first animal waste pad is defined and separated from the leading edge of a second animal waste pad by a perforation.

2. The roll of animal waste pads of claim 1 wherein a length of the center support exceeds the distance between the side edges of the plurality of pads.

3. The roll of animal waste pads of claim 1 wherein:
a length of the center support exceeds the distance between the side edges of the plurality of pads; and
the center support having peripheral ends that are configured to engage a means for rotatably supporting the animal waste pad roll with an animal waste pad dispenser.

4. For use in an animal waste pad dispenser that dispenses an animal waste pad for use by an animal, with the dispenser having opposing cradles in which a roll of animal waste pads can be supported, the improvement comprising:
a roll of animal waste pads wound on a roll support, the animal waste pads being separated from one another by perforations and having a first non-woven layer, a second absorbent layer and third substantially impermeable layer; and
the roll support being axially longer than the roll is wide, with the ends of the roll support projecting beyond the end of the roll a distance sufficient to enable the roll support to be rotatably held in the cradles.

5. A roll of animal waste pads comprising:
a substantially rigid center support;
a plurality of animal waste pads rolled around the center support and having,
a first layer made of a material with a wicking action,
a second absorbent layer, and
a third substantially impermeable backing layer;
each of the plurality of animal waste pads having leading, trailing and side edges;
the plurality of animal waste pads are consecutively connected together wherein a trailing edge of a first animal waste pad is defined and separated from the leading edge of a second animal waste pad by a perforation;
a length of the center support exceeds the distance between the side edges of the plurality of pads; and
the center support having peripheral ends that are configured to engage and be held within a means for dispensing animal waste pads from a roll.
